(19) United States
(12) Patent Application Publication
(10) Pub. No.: US 2003/0052563 A1
(43) Pub. Date: Mar. 20, 2003

(54) Electric machine

(76) Inventors: Karl Assmann, Nordheim (DE); Detlef Potoradi, Bad Neustadt (DE)

Correspondence Address: Henry M. Feiereisen, Suite 3220, 350 Fifth Avenue, New York, NY, 10118, US

(21) Appl. No.: 10/023,215

(22) Filed: Dec. 18, 2001

(30) Foreign Application Priority Data
Sep. 14, 2001 (DE) 101 45 555.0

(51) Int. Cl. H02K 1/00; H02K 3/00

(52) U.S. Cl. 310/179

(57) ABSTRACT

An electric machine, includes a stator, and a rotor interacting with the stator. The stator has a plurality of slots for placement of a winding with several coils. Each of the coils has several turns to thereby realize multi-layer coils and is defined by a coil beginning and a coil end, which are spatially separated from one another. Each layer of the coils has different ground capacitance, wherein a layer with smallest ground capacitance of a coil is connected to an input voltage of the electric machine.

### CROSS-REFERENCES TO RELATED APPLICATIONS

This application claims the priority of German Patent Application Serial No. 101 45 555.0, filed Sep. 14, 2001, the subject matter of which is incorporated herein by reference.

### BACKGROUND OF THE INVENTION

The present invention relates, in general, to an electric machine, and more particularly to an electric machine of a type having a stator, which includes a winding with several coils received in slots of the stator, and a rotor, which interacts with the stator, wherein each coil of the winding has several turns so as to realize multi-layer coils.

Electric machine are directly fed by the electric power system or via a converter. In the industrial field, mainly three-phase current motors are involved here. When three-phase current motors are concerned, which are fed by a converter, the voltage distribution in the winding is not linear. The winding of a three-phase current motor is comprised of several, normally three, strands, which in turn are made of coils that can be switched in series or in parallel. Each coil is made up of several turns which are insulated from one another by a thin coat of lacquer.

Very steep voltage impulses with buildup times of few nanoseconds are applied across the winding when voltage supply is involved via a converter or when switching operations are involved in the electric power supply system. In the frequency range, these steep flanks correspond to high limit frequencies of up to 30 MHz. As a consequence of the effective ground capacitance of the coils (capacitances to the grounded lamination stack of the stator of the electric machine) and the turns of the coils, the voltage distribution within the winding and even within the coil is not linear in this frequency range.

The winding may be considered, just as a conductor, as recurrent network system, whereby the smallest unit may be few turns or even only a single turn. The first coils or first turns of conventional windings are exposed to a greatest electrical load as a consequence of the non-linear voltage distribution. In the following description, the term “first coils” or “first turns” will denote “coils” or “turns” which are connected to the terminal of the electric machine and thus are connected by a cable to the power-supplying converter or to the electric power supply system. A greatest risk of destruction of the winding is encountered at the entry side of the winding as a result of shorted coils, when applied with such steep voltage impulses.

Attempts have been made to reduce the rate of rise in voltage by using smoothing chokes. Another proposal includes the reinforcement of the insulation at the winding entry.

It would be desirable and advantageous to provide an improved electric machine with a winding system, which obviates prior art shortcomings and is able to withstand a load experienced, when the voltage impulses are relatively high and steep.

### SUMMARY OF THE INVENTION

According to one aspect of the present invention, an electric machine, includes a stator having a plurality of slots for placement of a winding with several coils, each of the coils defined by a coil beginning and a coil end, which are spatially separated from one another, and having several turns to thereby realize multi-layer coils, with each layer of the coils having different ground capacitance, wherein a layer with smallest ground capacitance of a coil is connected to an input voltage of the electric machine.

Coils of this type can be implemented in an easy and efficient way by using toothed coils. The coils are wound about individual teeth. Thus, the coil width corresponds to the slot pitch. There are several ways in order to make such a winding. For example, the coils may be wound through the slots with a needle coiler, or coils may be wound onto single insulated tooth segments, which are then put together to form a stator.

According to another feature of the present invention, the coils are wound onto coil bodies of insulation material, e.g., plastic material. The lamination stack is made of two parts, namely a yoke stack and the teeth, which form a star-like stack. Wound coils are placed onto the teeth and the yoke stack and the star-like stack are subsequently joined coaxially together. As the coils are wound onto the coil carrier separately from the lamination stack, the winding can be wound in an orderly and controlled manner layer-by-layer.

This winding technique has many advantages, in particular as far as the electric strength is concerned. The coil ends are spatially separated from one another so that coil beginning and coil end may be disposed at different layers of the coil. The ground capacitance of individual layers varies. The outer layer has the slightest ground capacitance whereas the inner layer has the greatest ground capacitance. As a consequence, the equivalent circuit diagram of the recurrent network system of this coil is inhomogeneous. The coil end at the layer with slightest ground capacitance is electrically connected with the terminal of the electric machine, i.e. with the converter or the power supply system, and the coil end at the layer with high ground capacitance is connected to the next coil or to the star connection. As a consequence, an effective voltage distribution is realized across the windings of the respective strands, whereby the objective is then the realization of a linear voltage distribution. The initial layers of the coil with small ground capacitance near the coil end are spatially separated from the inner layer of this coil with high ground capacitance.

According to another feature of the present invention, the stator is structured coaxial and/or segment-like in circumferential direction, so that apart from the coils on the coil bodies, other winding methods may also be applied, to realize a winding that is formed layer-by-layer.

According to another aspect of the present invention, a method of making an electric machine, includes the steps of fabricating a stack of laminations for a stator, making multi-layer exciter or toothed coils, positioning the coils onto teeth of the stator; and placing the coils in such a manner that coil beginning and coil end extend out, wherein the coil beginning of slightest ground capacitance is connected to the input voltage.

Through the method according to the present invention, an electric machine can be made in a simple manner as a result of the simplified winding technique. An electric machine can therefore be created which is suitable for rate of rise of voltages in the nanoseconds range.

The lamination stack may be fabricated by stacking the laminations and blanking the stack of laminations.

Before positioned onto the teeth of the stator, the coils may be attached onto auxiliary bodies.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a principal illustration of an electric machine, incorporating the subject matter of the present invention;

FIG. 2 is a cross sectional view of a stator of an electric machine according to the present invention, illustrating coils and individual turns;

FIG. 3 is a cutaway view of the stator, showing in detail a tooth with attached coil; and

FIG. 4 is a flow diagram of making an electric machine in accordance with the present invention.

### DETAILED DESCRIPTION OF PREFERRED EMBODIMENTS

Throughout all the Figures, same or corresponding elements are generally indicated by same reference numerals.

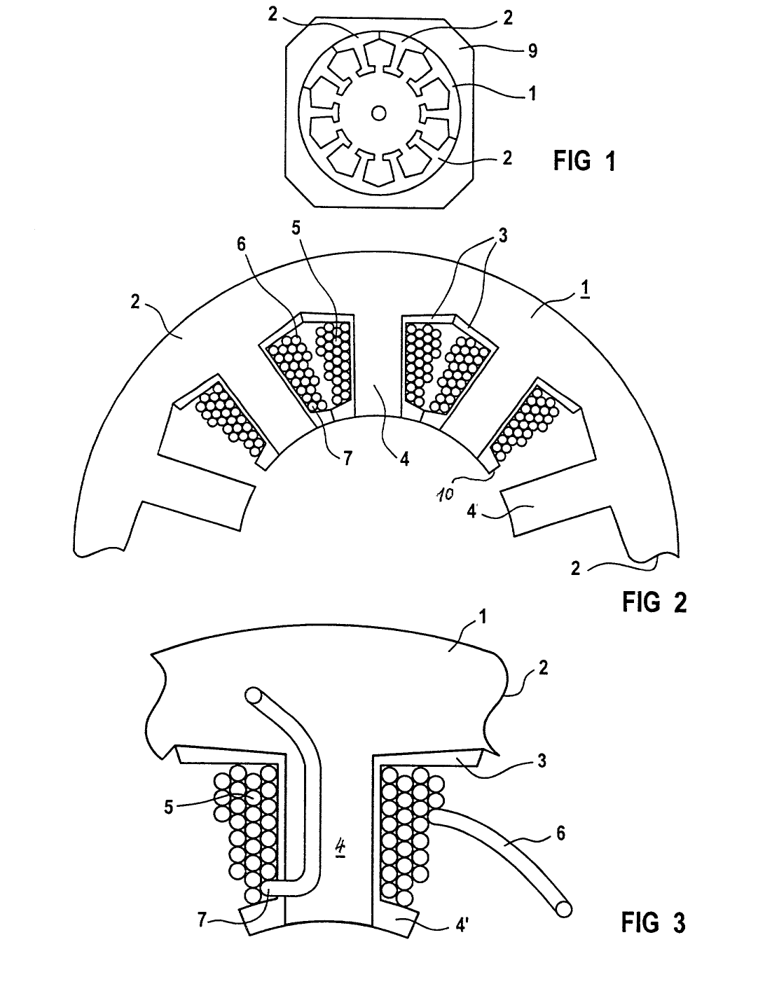

Turning now to the drawing, and in particular to FIG. 1, there is shown a principal illustration of an electric machine having a stator 1, which is composed of segments 2 in circumferential direction, and fitted in a casing 9, which further accommodates a, not shown, rotor for interaction with the stator 1. Although not shown in the drawing, the stator may also be split in axial direction.

The segments 2 may be interconnected by a material-based joint, form-fitting engagement, or frictional engagement. Each segment 2 is pre-fabricated with a winding so that the assembly of the electric machine requires only an electric and mechanical interconnection of the segments 2. Of course, the configuration of an electric machine according to the present invention is certainly equally applicable for a, not shown, housingless, electric machine.

FIG. 2 is a cross sectional view of the stator 1, illustrating in detail a one of the segments 2 for interconnection with other such segments 2 to realize the entire stator 1. The stator 1 is formed in radial direction with teeth 4 which are embraced by coil bodies 3 and carry the coils 5. The coils 5 are hereby so wound onto the teeth 4 in the thus-formed slots 10 that their coil beginning 6 is spatially separated from their coil end 7 (see also FIG. 3). The outer layer at the coil beginning 6 has the slightest ground capacitance, whereas the inner layer at the coil end 7 has the greatest ground capacitance. As a consequence, the circuit diagram of the recurrent network system is inhomogeneous. The coil beginning 6 at the layer with slight ground capacitance is electrically connected to a terminal of the electric machine, i.e., with a converter or an electric power supply system, whereas the coil end 7 at the layer with high ground capacitance is connected to the next coil 5 of this phase, or to a, not shown, star connection. As a result, an extremely effective voltage distribution at operation in the range of up to few MHz is realized.

FIG. 3 is a cutaway view of the stator 1, illustrating in detail a single tooth 4 of a one of the segments 2 which can be arranged in circumferential direction side-by-side to form the stator I and connected through a material-based joint, form-fitting engagement or frictional engagement. In particular, dovetail-type connections and/or bonding connections and/or welded connections are conceivable in this connection. FIG. 3 shows in particular the coil beginning 6 at the outermost layer of the coil 5 for electric connection to a terminal of the electric machine, i.e., with a converter or an electric power supply system, and the coil end 7 at the innermost layer for electric connection with the next coil 5 of this phase, or with a, not shown, star connection.

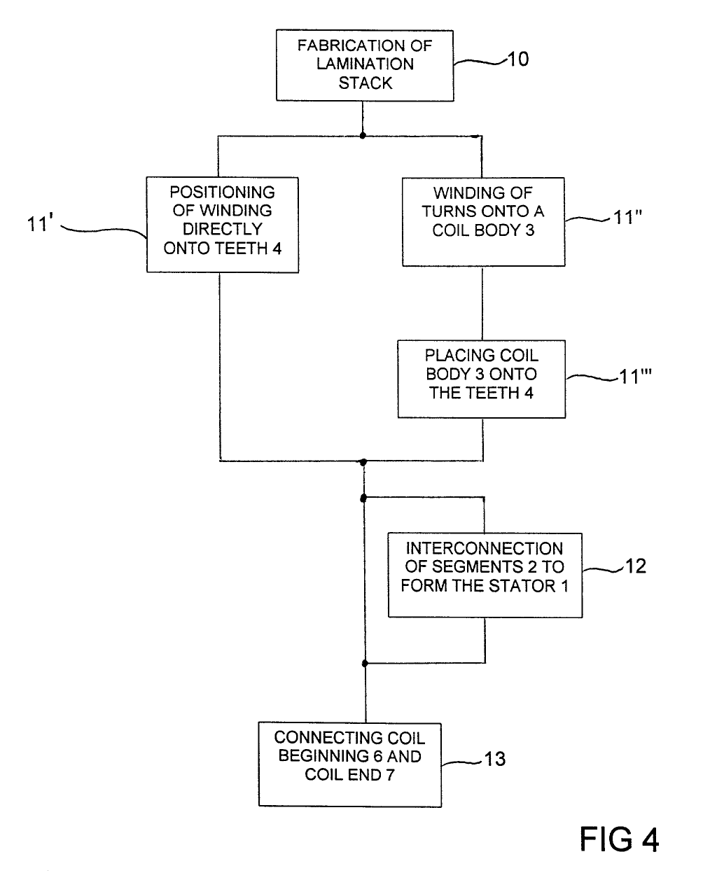

Referring now to FIG. 4, there is shown a flow diagram of making an electric machine in accordance with the present invention. In a first step, labeled by box 10, the stator 1 is made from a stack of laminations or segments 2 thereof by stacking the laminations or segments 2 and blanking or punching the stator stack. Of course other techniques may be equally applicable, for example, sintering operations to make the stator 1 or segments 2 thereof. The next step, involves the positioning of the windings onto teeth 4 of the stator 1. This may be implemented by directly winding the turns of the coil 5 onto the teeth 4, as depicted by the box labeled 11′. As an alternative, it is also conceivable to wind the turns of the coil 5 first onto a coil body 3, as depicted by the box labeled 11″, and subsequently radially placing the coil body 3 with attached coil 5 onto the tooth 4, as depicted by the box labeled 11′″. Care should be taken to effect a layered configuration of the winding. The teeth 4 have each a tooth end portion 4′ (FIG. 3) which should be so configured as to facilitate a positioning of the coil 5 or of the coil body 3. Advantageously, the tooth 4 has hereby parallel flanks.

As soon as the teeth 4 are provided with windings, i.e., coils 5, the stator 1 is assembled. If necessary, the stator may also be assembled by interconnecting the segments 2, as indicated by the box labeled 12. Any suitable connecting technique may be applicable here.

In the next step, labeled 13, the coil beginnings 6 and the coil ends 7 are connected in a manner described above.

Optionally, the coils 5 or the coil bodies 3 with attached coils 5 may be cast with the formed stator 1 to thereby effect in particular an additional securement of the coils 5 and possible segments 2.

While the invention has been illustrated and described as embodied in an electric machine, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. An electric machine, comprising:
a stator; and
a rotor interacting with the stator,
wherein the stator has a plurality of slots for placement of a winding with several coils, each of the coils defined by a coil beginning and a coil end, which are spatially separated from one another, and having several turns to thereby realize multi-layer coils, with each layer of the coils having different ground capacitance, wherein a layer with smallest ground capacitance of a coil is connected to an input voltage of the electric machine.

2. The electric machine of claim 1, wherein the stator has a coaxial configuration.

3. The electric machine of claim 1, wherein the stator includes segments arranged in circumferential direction of the stator.

4. A method of making an electric machine, comprising the steps of:
fabrication of a stack of laminations for a stator;
making multi-layer exciter or toothed coils;
positioning the coils onto teeth of the stator; and
placing the coils in such a manner that coil beginning and coil end extend out, wherein the coil beginning of smallest ground capacitance is connected to an input voltage.

5. The method of claim 4, wherein the fabrication step is implemented by stacking and blanking the laminations.

6. The method of claim 4, wherein the coils are attached onto auxiliary bodies before being positioned onto the teeth of the stator.

7. The method of claim 4, wherein the stator has at least one configuration selected from the group consisting of coaxial configuration and segmental configuration.
